(19) United States
(12) Patent Application Publication
(10) Pub. No.: US 2009/0307264 A1
(43) Pub. Date: Dec. 10, 2009

(54) OBJECT ACQUISITION DEVICE, OBJECT MANAGEMENT SYSTEM, AND OBJECT MANAGEMENT METHOD

(75) Inventors: Shinji Makishima, Sumida-ku (JP); Kazuhiro Ogura, Hiratsuka-shi (JP); Akihiro Mizutani, Kawasaki-shi (JP); Toshihiro Ida, Ota-ku (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/476,656

(22) Filed: Jun. 2, 2009

Related U.S. Application Data
(60) Provisional application No. 61/059,104, filed on Jun. 5, 2008.
(60) Provisional application No. 61/059,107, filed on Jun. 5, 2008.

(51) Int. Cl. G06F 17/30

(52) U.S. Cl. 707/103 R; 707/E17.055

(57) ABSTRACT

Provided is a technology through which acquisition and management of an object used in a document can be performed more easily compared with a known technology.

An object acquisition device includes: an object extracting unit configured to extract an object disposed on a page image on the basis of print job data for generating the page image; a meta data generating unit configured to generate meta data including information relating to the object extracted by the object extracting unit on the basis of information extracted from the print job data; and a registration unit configured to register the object extracted by the object extracting unit and the meta data generated by the meta data generating unit by associating each other.

### CROSS-REFERENCE TO RELATED APPLICATION

This application is based upon and claims the benefit of priority from: U.S. provisional application 61/059,104, filed on Jun. 5, 2008; and 61/059,107, filed on Jun. 5, 2008; the entire contents of each of which are incorporated herein by reference.

### TECHNICAL FIELD

The present invention relates to an object management system, and more particular to, an object management system in which an object included in print job data is acquired and registered, and can be used by search.

### BACKGROUND

In the past, a technology (JP-A-8-161350) is known in which a document created by an application is interpreted, text information of the document is created, and the document and the text information is associated with each other to be registered. By searching the registered document on the basis of the text information, a user can use objects included in the document.

However, the document includes various components such as plural objects in many cases. Therefore, in order to search an object deemed to be included in the document, the user is necessary to first refer the created text information, and then refer the document which is deemed to include a desired object from the text information.

### SUMMARY

An advantage of some embodiments of the invention is to provide a technology of an object acquisition and management, through which it is possible to easily perform the acquisition and the management of the object used in the document.

In order to solve the above problem, according to an aspect of the invention, there is provided an object acquisition device which includes: an object extracting unit for extracting an object disposed on a page image on the basis of print job data for generating the page image; a meta data generating unit for generating meta data including information relating to the object extracted by the object extracting unit on the basis of information extracted from the print job data; and a registration unit for registering the object extracted by the object extracting unit and the meta data generated by the meta data generating unit by associating each other.

In addition, according to another aspect of the invention, there is provided an object management system which includes: an object extracting unit for extracting an object disposed on a page image on the basis of print job data for generating the page image; a meta data generating unit for generating meta data relating to the object extracted by the object extracting unit on the basis of information extracted from the print job data; a storage unit for storing the object and the meta data; a registration unit for registering the object extracted by object extracting unit with the meta data generated by the meta data generating unit on the storage unit by associating each other; and a search unit for searching the object registered on the storage unit.

In addition, according to still another aspect of the invention, there is provided an object management method which includes: extracting an object disposed on a page image on the basis of print job data for generating the page image; generating meta data relating to the extracted object on the basis of information extracted from the print job data; registering the extracted object and the generated meta data by associating each other and storing; and searching the stored object.

In addition, according to still another aspect of the invention, there is provided an object management program causing a computer to perform management of an object, the object management program including: extracting an object disposed on a page image on the basis of print job data for generating the page image; generating meta data relating to the extracted object on the basis of information extracted from the print job data; registering the extracted object and the generated meta data by associating each other and storing; and searching the stored object.

### DESCRIPTION OF THE DRAWINGS

FIG. 1 is a block diagram schematically illustrating a configuration of an object management system according to a first embodiment of the invention.

FIG. 2 is a functional block diagram of a client PC 101 according to the first embodiment of the invention.

FIG. 3 is a view illustrating an example of a document created by an application installed on the client PC 101 according to the first embodiment of the invention.

FIG. 4 is a view illustrating an example of meta data created by a meta data generating unit 13 according to the first embodiment of the invention.

FIG. 5 is a functional block diagram of an object management server 103 according to the first embodiment of the invention.

FIG. 6 is a view illustrating an example of an object management table stored in a storage unit 31 according to the first embodiment of the invention.

FIG. 7 is a view illustrating an example of a meta data management table stored in the storage unit 31 according to the first embodiment of the invention.

FIG. 8 is a view illustrating an example of a window for requesting an object search according to the first embodiment of the invention.

FIG. 9 is a view illustrating an example of a window for requesting an object search by using text information according to the first embodiment of the invention.

FIG. 10 is a view illustrating an example of a window for requesting an object search by using a reference image according to the first embodiment of the invention.

FIG. 11 is a flowchart illustrating a process of object extraction and meta data generation according to the first embodiment of the invention.

FIG. 12 is a flow chart illustrating a process of an object search request according to the first embodiment of the invention.

FIG. 13 is a flowchart illustrating aprocess of an object search according to the first embodiment of the invention.

FIG. 14 is a functional block diagram of a print server 102 according to a second embodiment of the invention.

FIG. 15 is a flowchart illustrating a process of object extraction and meta data generation according to the second embodiment of the invention.

FIG. 16 is a flowchart illustrating a process of search and replacement of an object according to a third embodiment of the invention.

FIG. 17 is a view illustrating an example of a window for requesting object replacement according to the third embodiment of the invention.

### DETAILED DESCRIPTION

Hereinafter, embodiments of the invention will be described with reference to the accompanying drawings.

### First Embodiment

First, a first embodiment of the invention will be described now.

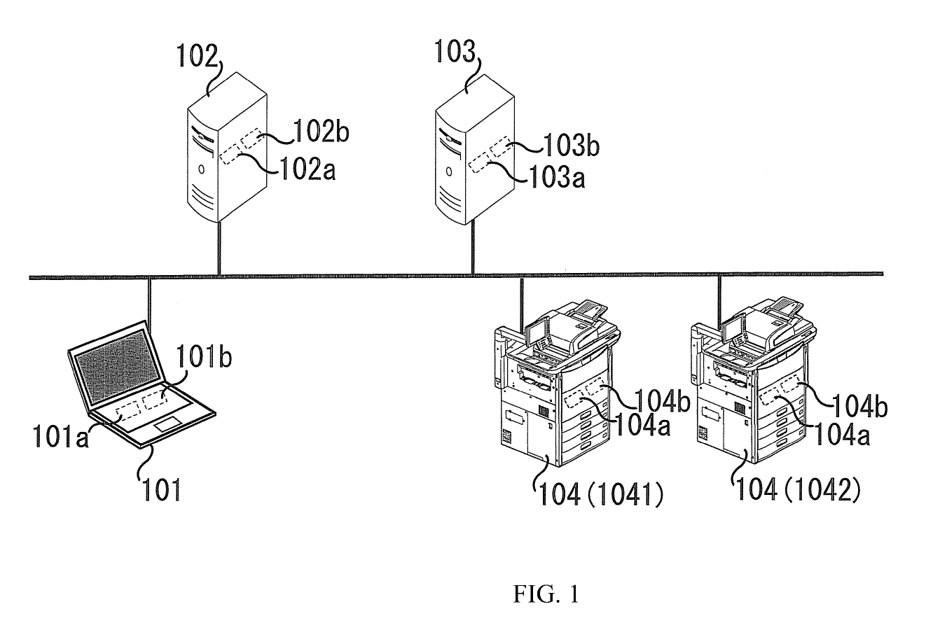

FIG. 1 is a block diagram schematically illustrating a configuration of an object management system (hereinafter, simply referred to as “management system”) according to a first embodiment.

As shown in FIG. 1, the management system includes a client PC 101, a print server 102, an object management server 103, and one or more multi function peripherals (MFPs) 104 (1041 and 1042 in the first embodiment). In addition, the respective structural components are connected via a network such as LAN, WAN, and wireless LAN.

Each of the structural components of the client PC 101, the print server 102, and the object management server 103 includes standard components which are built on a general purpose computer. For example, as such a standard component, CPU, RAM, ROM, hard disk, external storage device, network interface, display, keyboard, and mouse are exemplified. Similarly, also the MFP 104 includes the standard components such as CPU, RAM, ROM, hard disk, scanner, printer, display, operational unit such as a touch panel and buttons, and interface for performing communication with the outside.

Further, a sign refers to a symbol used for indicating a constant matter, a mark, and a character drawn by a specific font.

A figure refers to a set of surfaces, lines, dots and the like.

A shape refers to a diagrammatic drawing, a color coding, or a gradation.

Furthermore, an image refers to a concept including a computer graphic or the like created by an application of the computer other than a photographic image.

In the client PC 101, a document is created such that an internal CPU 101a performs the application program stored in a storage area 101b such as a ROM. A printer driver 1 (to be described in detail later) which is a program installed on the client PC 101 creates print job data of the document created by the application. Next, the printer driver 1 sends out the created print job data to the MFP 104 via the print server 102.

In the first embodiment, the printer driver 1 extracts the objects such as a sign, a figure, a shape, and an image from the print job data. Further, the printer driver 1 generates meta data relating to the extracted object on the basis of information extracted from the print job data. Then, the printer driver 1 registers the extracted object and the generated meta data on the object management server by associating each other. That is, in the first embodiment, the client PC 101 corresponds to the object acquisition device.

The print server 102 temporarily stores the print job data sent out from the client PC 101, and sends out the data to the MFP 104 which is identified or designated by the user. In addition, the print server 102 can also perform a predetermined process on the temporarily-stored print job data such that an internal CPU 102a performs a program stored in a storage area 102b.

The object management server 103 registers and manages the object output from the print job data and the meta data generated on the object such that an internal CPU 103a performs a program stored in a storage area 103b. In addition, the object management server 103 searches the registered object on the basis of information included in the meta data or a reference image, and the registered object is sent out to the client PC 101.

The MFP 104 includes a monochrome or a color copy function, a monochrome or a color scanner function, a monochrome or a color printer function, and the like. In addition, the MFP 104 is connected to a network, so that it is configured such that a scanned image can be transmitted to a desired site by using E-mail, the scanned image is stored and can be exchanged with image data via the network, or a function of a network printer or a facsimile can be implemented. Furthermore, the MFP 104 can also perform a predetermined process for the acquired scanned image or the like such that an internal CPU 104a performs a program stored in a storage area 104b.

Next, a function of extracting the object from the print job data and a function of generating the meta data on the object according to the first embodiment will be described now.

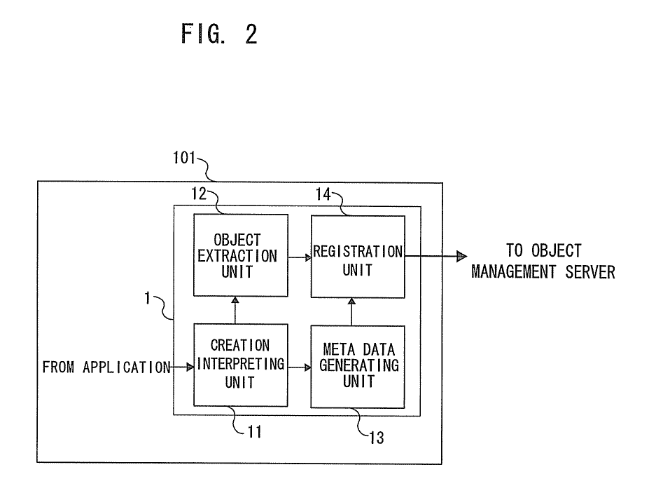

FIG. 2 shows a block diagram illustrating a configuration relating to an object extracting function and a meta data generating function of the printer driver 1 built on the client PC 101. The printer driver 1 includes a creation interpreting unit 11, an object extracting unit 12, a meta data generating unit 13, and a registration unit 14.

When acquiring a drawing command of a document from the application of the client PC 101, the creation interpreting unit 11 creates the print job data for generating a page image from the document. The created print job data is spooled in the storage area 101b, such as a memory and a hard disk, in the file format of a page description language (PDL) such as the Post Script. The creation interpreting unit 11 reads out the spooled print job data to be sent out to the MFP 104, and performs an output process on a paper medium.

In addition, the creation interpreting unit 11 performs a layout interpretation on the spooled print job data, and identifies a text area, an image area, a background area (a header or a footer of the document, a design template configured of the background etc.), and the like. In addition, in the layout interpretation, among the objects of signs, figures, shapes, images, and the like, the objects which have an appearance frequency in the print job data greater than a predetermined value can be sorted out as the background area. In addition, the objects having the appearance frequency smaller than the predetermined value can be sorted out as the image area.

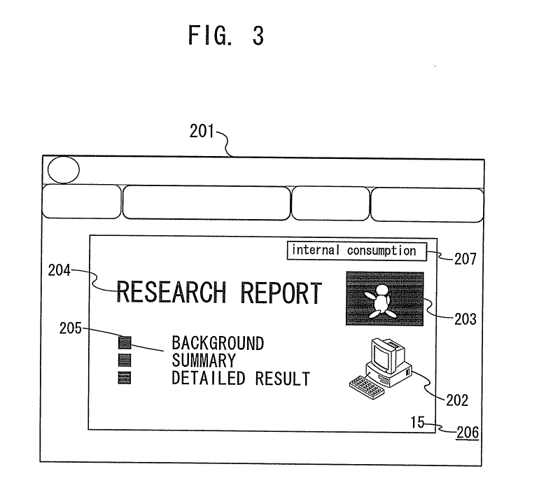

FIG. 3 is a view illustrating an example of a page image 201 generated from the print job data. In the drawing, a vector image 202 and a bit map image 203 obtained by capturing a clip art or an image which are used an illustrating are identified as the image area. In addition, a title 204, a body 205, and a page number 206 are identified as the text area. Further, a header 207 is identified as the background area. The creation interpreting unit 11 sends out results of the layout interpretation to the object extracting unit 12 and the meta data generating unit 13.

The object extracting unit 12 extracts the object disposed on the page image from the print job data. More specifically, the object extracting unit 12 uses the results of the layout interpretation acquired from the creation interpreting unit 11, and extracts a drawing command (object) from the image area included in the spooled print job data. In the case of the bit map image, a bit map drawing command becomes the object. In addition, in the case of the vector image such as a figure, a set of the vector image drawing commands in an area becomes the object. Next, the object extracting unit 12 outputs the extracted object as a file. The file format may be a format generally used in the clip art such as a windows meta file (WMF) or the Post Script, for example.

In addition, the object extracting unit 12 extracts a set of the drawing commands (a design template, hereinafter, simply also referred to as “template”) as the object from the background area identified by the layout interpretation. The set of the extracted drawing commands is transformed into a file format of a design template (a file format has a filename extension such as “dot”, “pot”, or “elt”) which is used by the application, and then is output as a file. As a transformation scheme, a character drawing command is transformed into a text, a bit map drawing command is transformed into a bit map image, a figure drawing command is transformed into the WMF or the like, and each of which is output in alignment with a drawing position thereof.

The object extracting unit 12 sends out the file of the object, which is extracted as described above, to the registration unit 14.

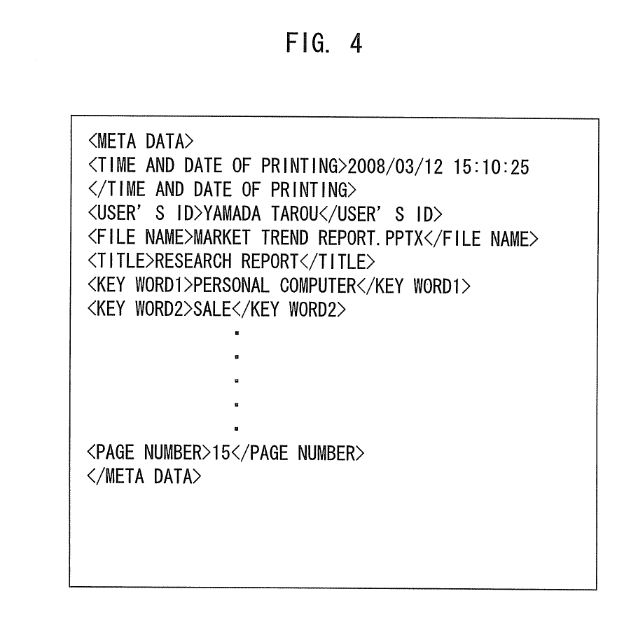

The meta data generating unit 13 generates the meta data as shown in FIG. 4, which relates to the object extracted by the object extracting unit 12, on the basis of the information extracted from the print job data.

The generation of the meta data will be described in more detail.

The meta data generating unit 13 first uses the layout interpretation result acquired from the creation interpreting unit 11, and extracts a character code from the character drawing command of the text area included in the print job data, and then transforms the extracted character code into text data. Here, based on position coordinates of the character drawing command, for example, the data corresponding to the vicinity of the upper center portion of a page is transformed into a title, and the data corresponding to the vicinity of the lower right portion of the page is transformed into a page number. Setup positions of these title and page number may be configured to be changed according to the application sending out the drawing command to the printer driver 1.

Next, the meta data generating unit 13 performs, for example, a morphological analysis on the text data to extract nouns which are set as key words. Here, among the nouns included in the text data, the meta data generating unit 13 may be configured to set the nouns satisfying predetermined conditions to the key words. For example, in the document, the data having a high appearance frequency (the data which has a lot of the same phrases), the data having a big font, and the data using a highlight attribute such as a bold type or a red color may be set to the key words.

The meta data generating unit 13 generates the meta data on the basis of the key words set as described above and information associated with the print job data, such as a title, a page number, a time and date of printing (a created time and date of the print job data), a file name, a created time and date of a file which is the basis of the print job data, and a logged-in user's name of the client PC 101 (a name of user who creates the print job data). In addition, the meta data generating unit 13 can acquire the information associated with the print job data by the use of an application program interface (API) not shown, or the like. The meta data generating unit 13 sends out the generated meta data to the registration unit 14.

The registration unit 14 associates the object extracted by the object extracting unit 12 with the meta data generated by the meta data generating unit 13, sending out these to the object management server 103 to register the object and the meta data. Here, for example, the registration unit 14 gives the object an identification ID for identifying, and gives the meta data an identification ID associated with the identification ID of the object, and thereby associating the object with the meta data.

Next, management and search functions of the object stored in the object management server 103 according to the first embodiment will be described now.

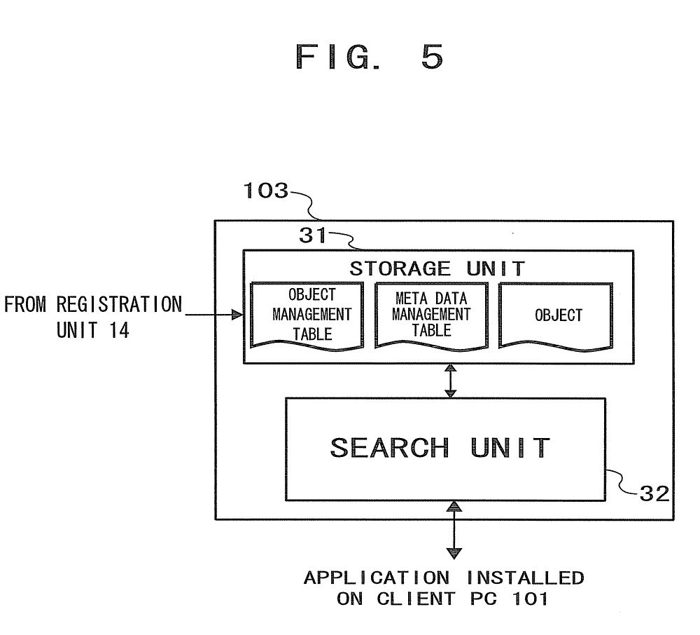

FIG. 5 shows a block diagram illustrating a configuration relating to the management and search functions of the object in the object management server 103. The object management server 103 includes a storage unit 31 and a search unit 32. The storage unit 31 is configured of the storage area 103b, for example, the hard disk. By this, the storage unit 31 can implement a function of database.

The storage unit 31 stores and manages the object acquired from the registration unit 14 of the client PC 101 and the meta data including the information associated with the object. Specifically, the storage unit 31 stores the object, keeping an object management table and a meta data management table, and performing the management of the object by using the management tables.

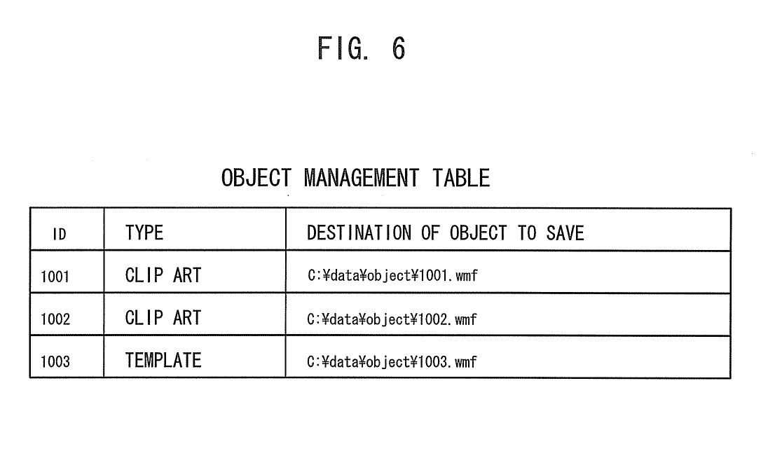

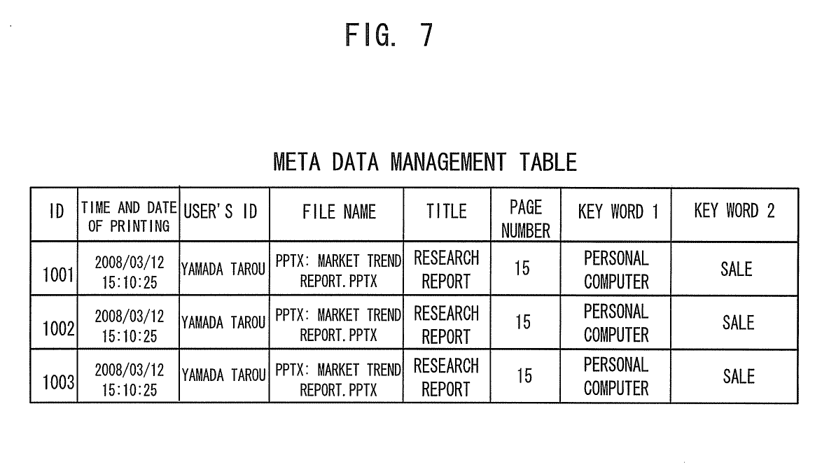

FIGS. 6 and 7 show examples of the object management table and the meta data management table. The object management table shown in FIG. 6 is a table for managing an ID, the type of the stored object such as a figure, a clip art, an image, and a template, and a destination of the object to save.

The meta data management table shown in FIG. 7 is a table for managing an ID associated with the ID of the object management table and the meta data shown in FIG. 4.

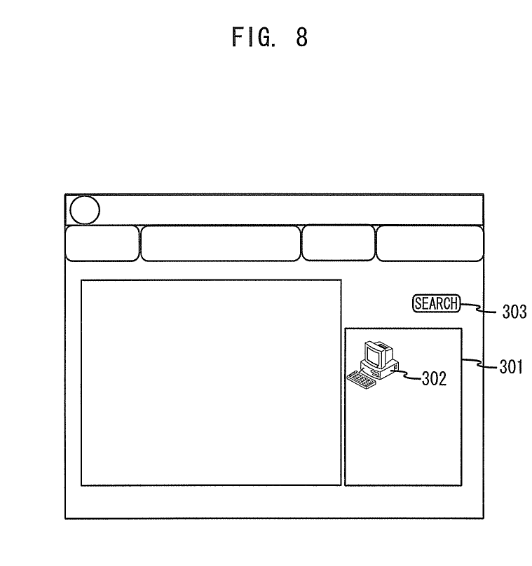

Next, before describing a function of the search unit 32, examples of a screen which can be used in the client PC 101 to request the search unit 32 to search will be described with reference to FIGS. 8, 9 and 10.

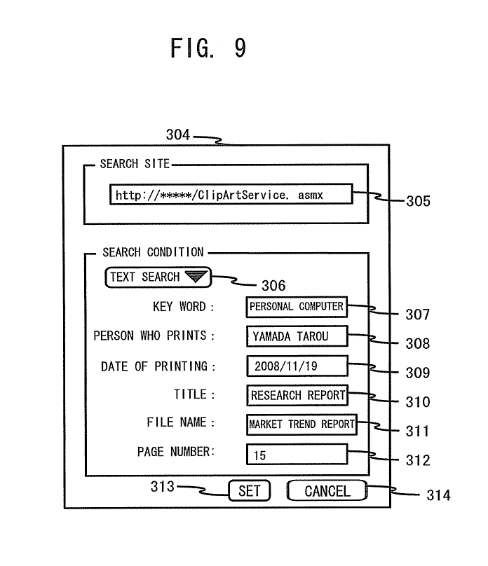

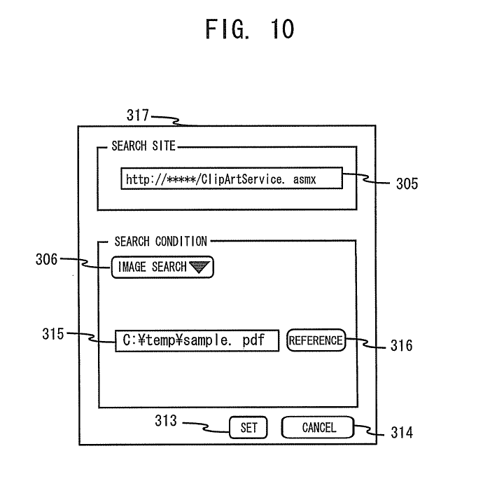

FIG. 8 shows a window of the application under execution on the client PC 101, which is displayed on a display of the client PC 101. By performing an instruction on the application, a user can display a button 303 for searching the object and a sub window 301 for listing and displaying thumbnail images of the detected object. When the user presses the button 303, a window for setting a search site and search conditions as shown in FIG. 9 or FIG. 10 is displayed on the display of the client PC 101.

FIG. 9 shows a text search window in a case of searching the object by using text information (more particularly, a search formula to be created on the basis of the text information) such as the key words input by the user. In addition, FIG. 10 shows an image search window in a case of searching the object by using a reference image including the object in part or in whole.

Here, the reference image refers to an image file (raster image data in a PDF or TIFF format) acquired by scanning of a scanner or the like, including one or plural objects, and being able to used for searching the object stored in the storage unit 31. The user may want to use the object which is matched with or similar to the clip art or the design template drawn on the paper medium at user's own hands, in order to create a document. Since it is possible to perform the search by using the reference image, the user scans the paper medium with the object drawn thereon and can perform the search by using the scanned image data. Therefore, even when the user does not know well about the desired object, it is possible to perform the search.

That is, in the object management system according to the first embodiment, the search unit 32 of the object management server 103 acquires reference information (text information), which is information for searching the object, for example, a key word. Further, among the objects stored in the storage unit 31, the search unit 32 searches the object which is matched or associated with the information on the object in part or in whole included in the meta data.

In addition, in the object management system according to the first embodiment, the search unit 32 of the object management server 103 acquires the reference image which is used for searching the object stored in the storage unit 31 and includes the object in part or in whole. Further, among the objects registered on the storage unit, the search unit 32 searches the object which is matched with or similar to the object in part or in whole included in the reference image (a so-called similar image searching technology).

First, a text search window 304 shown in FIG. 9 will be described now.

The text search window 304 is a window for setting the search site and the search conditions in a case of performing the search by using the text information. The window 304 is provided by the application under execution on the basis of the press of the button 303.

A text box 305 is an entry field for inputting a site to be searched. In the first embodiment, an address of the object management server 103 is input to the text box.

A list box 306 lists and displays the text search window shown in FIG. 9 and the image search window shown in FIG. 10. By performing a selecting operation on the list box 306, the user can switch between the text search window shown in FIG. 9 and the image search window shown in FIG. 10, and all of which are displayed on the display of the client PC 101.

Text boxes 307 to 312 are entry fields for inputting text information as the search conditions.

A button 313 is a button for confirming the search site and the search conditions to send out a search request to the search unit 32. A button 314 is a button for canceling the sending out of the search request.

Next, a screen shown in FIG. 10 will be described. The explanation of the same configurations as those in FIG. 9 will be omitted.

A text box 315 shown in FIG. 10 is an entry field for inputting a path of the reference image file in a case of the reference image being used for the search. When a button 316 is pressed, a file management tool is executed which is used for the management and search of a file or a folder. When the reference image file is selected by the user, the path of the reference image file is input to the text box 315.

In this way, the information relating to the set search site and the set search conditions is sent out to the object management server 103 to be used in the server 103 to process the search of the object. Here, in a case of performing the search by using the text information, when plural conditions are input in at least one of the text box among the text boxes 307 to 312, a search formula may be created and sent out to the object management server 103 in order to perform the search under an OR condition of these input conditions. In addition, when conditions are input in plural text boxes among the text boxes 307 to 312, the search formula may be created and sent out to the object management server 103 in order to perform the search under an AND condition of these input conditions. On the other hand, in a case of the reference image, the image file itself is sent out to the object management server 103 together with the search request.

Next, a function of the search unit 32 will be described now.

When acquiring the search request from the client PC 101, the search unit 32 searches the object registered on the storage unit 31, and sends out the detected object to the client PC 101.

A searching process of the object by the use of the search unit 32 will be described in detail.

The search unit 32 determines whether or not the search request complies with the search formula to be used for performing the search by using the text information. When the search request complies with the search formula, the search unit 32 searches the object which is included the storage unit 31 and includes the matched or associated information in the meta data on the basis of the search formula.

On the other hand, when not complying with the search formula, the search request is acquired in accordance with the reference image in the first embodiment. The search unit 32 performs the layout interpretation on the reference image, and identifies one or plural image areas and the background areas which are included in a sampled image. Next, the search unit 32 extracts the object (image data such as a bit map) from the image area. Then, among the objects registered on the storage unit 31, the search unit 32 searches the object which is matched with or similar to the object in part or in whole included in the extracted reference image. Here, in the first embodiment, the object managed in the server is a vector image. Therefore, as an example of a search method, a set of feature points of outlines is extracted from, for example, image data (bit map) of the object in the reference image through image processing. Then, the extracted feature points are subjected to be matched with the feature points of the managed vector image. Accordingly, the object being matched or similar is searched.

The search unit 32 sends out the object detected by the above-mentioned search method to the client PC 101 of a request source.

The application executed on the client PC 101 spools the acquired object file in the storage area 101b such as a memory or a hard disk. In addition, the application creates the thumbnail image 302 of the acquired object as shown in FIG. 8 and displays the image in the sub window 301 of the application. The user can append the spooled object to the created document in the application under execution by selecting the displayed thumbnail image with a mouse or using a drag-and-drop function.

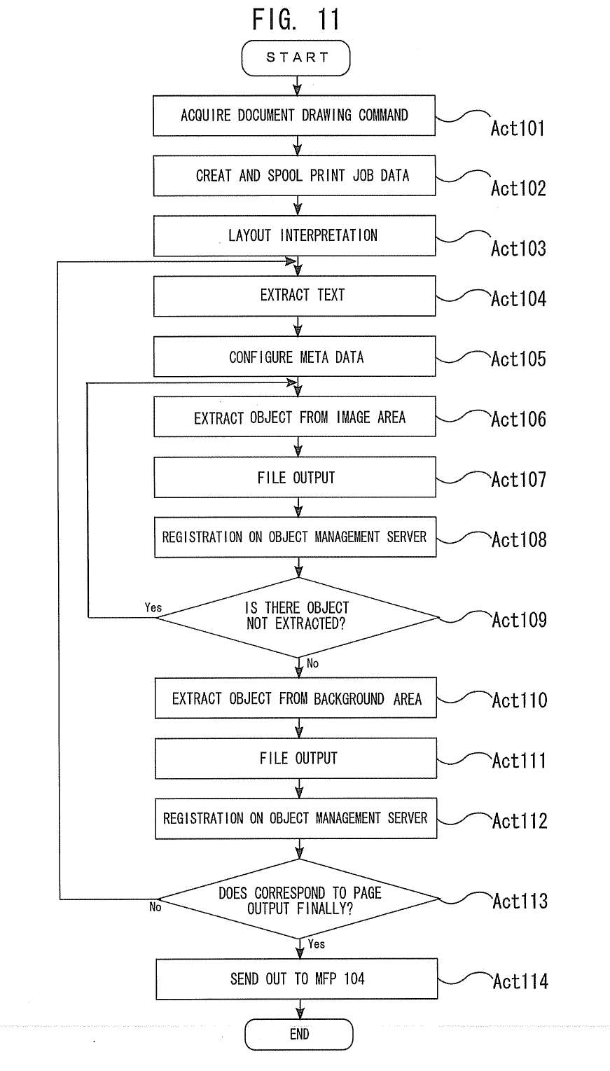

Hereinafter, the extraction of the object from the print job data and the generation of the meta data according to the first embodiment will be described in detail with reference to FIG. 11. In the first embodiment, the object extracting unit 12 of the printer driver 1 extracts a set of drawing commands included in the image area and drawing commands included in the background area in the print job data as the object.

First, in Act 101, the creation interpreting unit 11 acquires the drawing command of the document from the application of the client PC 101. Next, in Act 102, the creation interpreting unit 11 creates the print job data for generating a page image from the document, and spools the print job data in the storage area 101b such as the memory or the hard disk.

The creation interpreting unit 11 proceeds to Act 103, performing the layout interpretation on the spooled print job data, and identifying the text area, the image area, the background area, and the like. Then, the creation interpreting unit 11 sends out the layout interpretation result to the object extracting unit 12 and the meta data generating unit 13.

In Act 104, the meta data generating unit 13 extracts the character code from the character drawing command of the identified text area on the basis of the layout interpretation result acquired from the creation interpreting unit 11, and transforms the character code into the text data.

Next, in Act 105, the meta data generating unit 13 performs the morphological analysis on the transformed text data to extract the nouns which are set as the key words. The meta data generating unit 13 combines the set key words and the information relating to the print job data such as a time and data of printing acquired by using the API (not shown) of the client PC 101, a file name, a logged-in user's name of the client PC 101, and thereby generating the meta data. The meta data generating unit 13 sends out the generated meta data to the registration unit 14.

On the other hand, in Act 106, the object extracting unit 12 extracts the drawing command (object) from the image area identified by the layout interpretation result acquired from the creation interpreting unit 11. Next, in Act 107, the object extracting unit 12 outputs the acquired object as a file. The object extracting unit 12 sends out the file of the output object to the registration unit 14.

Then, in Act 108, the registration unit 14 associates the object file acquired from the object extracting unit 12 with the meta data acquired from the meta data generating unit 13, and all of which are registered on the storage unit 31 of the object management server 103.

In Act 109, the object extracting unit 12 determines whether or not there is an object not extracted in the image area on the basis of the layout interpretation result. When there is an object not extracted in the image area (Yes in Act 109), the object extracting unit 12 and the registration unit 14 repeat the processes from Act 106 to Act 109.

When there is no object not extracted in the image area (No in Act 109), the object extracting unit 12 performs the extraction of the object also on the set of the drawing commands included in the background area (Act 110). Next, the object extracting unit 12 outputs the extracted object as a file to be sent out to the registration unit 14 (Act 111). Then, the registration unit 14 associates the object output as a file with the meta data acquired from the meta data generating unit 13, and registers all of which to the storage unit 31 of the object management server (Act 112).

In Act 113, the object extracting unit 12 determines whether or not the data subjected to the extraction of the object corresponds to the page output finally among the print job data. When the data subjected to the extraction of the object among the print job data does not correspond to the page output finally (No in Act 113), the printer driver 1 repeats the processes from Act 104 to Act 112.

When the data subjected to the extraction of the object among the print job data corresponds to the page output finally (Yes in Act 113), the printer driver 1 sends out the spooled print job data to the MFP 104, and makes the print process be performed (Act 114).

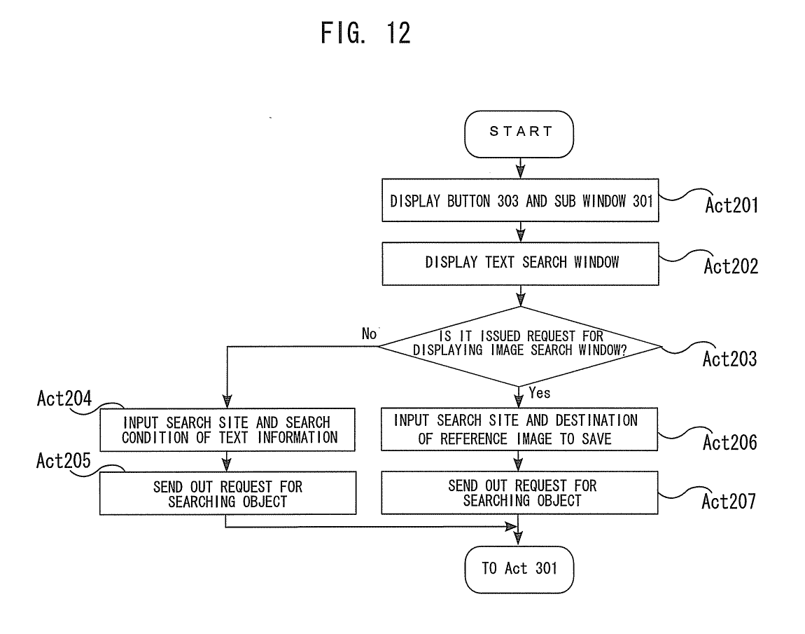

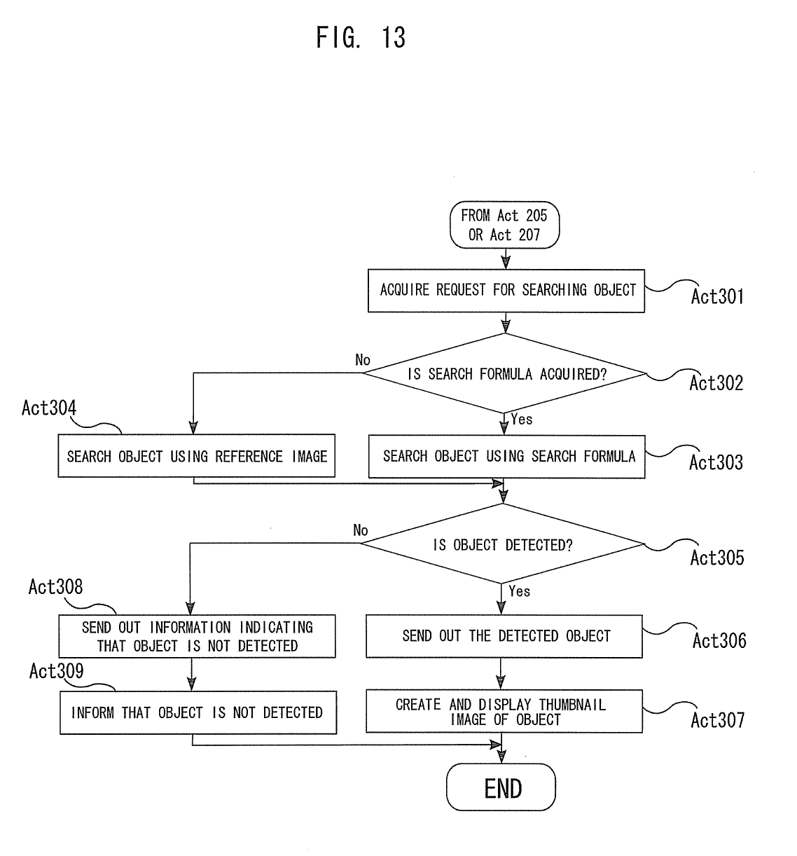

Then, the search of the object stored in the object management server 103 according to the first embodiment will be described in detail using FIGS. 12 and 13. In the first embodiment, the search unit 32 uses the search formula created from the text information or the reference image in order to search the object acquired from the client PC 101, and searches the object stored in the storage unit 31.

Specifically, first in Act 201, the application under execution in the client PC 101 displays the button 303 and the sub window 301 in the window of the application in response to the user's request for supply as shown in FIG. 8. When the user presses the button 303, the application displays the text search window (see FIG. 9) for performing the search by using the text information (Act 202). In addition, by performing a selecting operation on the list box 306 in the text search window, the user may request the image search window to be displayed for performing the object search by using the reference image as exemplified in FIG. 10 (Act 203). When there is a request for displaying the image search window (Yes in Act 203), the application of the client PC 101 displays the image search window on the display of the client PC 101.

When wanting to search by using the text information, the user inputs the search site and the search conditions of the text information in the text boxes 305 and 307 to 312 in the text search window 304, and presses button 313 (Act 204). By this, the application of the client PC 101 sends out the search formula created on the basis of the input text information and the object search request to the search unit 32 of the object management server 103 (Act 205).

In addition, when wanting to search the object by using the reference image, the user inputs the search site and the destination of the reference image to save to the text boxes 305 and 315 in the image search window 317, and presses the button 313 (Act 206). By this, the application of the client PC 101 sends out the reference image and the object search request to the search unit 32 of the object management server 103 (Act 207).

As shown in FIG. 13, the search unit 32 acquires the object search request from the application of the client PC (Act 301), and determines whether or not the search formula is acquired along with the object search request (Act 302).

When the search formula is acquired (Yes in Act 302), the search unit 32 searches the object, stored on the storage unit 31, in which the information of the text in the text search screen is matched or associated with the information included in the meta data (Act 303).

Next, the search unit 32 determines whether or not the object in which the information of the text is matched or associated with the information included in the meta data (Act 305). When the object is detected (Yes in Act 305), the search unit 32 sends out the object file to the client PC (Act 306). On the other hand, when the object is not detected (No in Act 305), the search unit 32 sends out information to the client PC in order to inform that the object cannot be detected (Act 308).

Similarly, when the reference image is acquired (No in Act 302), the search unit 32 searches the object, which is matched with or similar to the object included in the reference image, in the storage unit 31 (Act 304).

Next, the search unit 32 determines whether or not the object which is matched with or similar to the reference image is detected (Act 305). When the object is detected, the search unit 32 sends out the object file to the client PC 101 (Act 306). On the other hand, when the object is not detected, the search unit 32 sends out information to the client PC 101 in order to inform that the object cannot be detected (Act 308).

The application of the client PC 101 spools the acquired object file to the storage area 101b, generating the thumbnail image to be displayed in the sub window 301 (Act 308). The user can append the spooled object to the document by selecting or using the drag-and-drop function with respect to the thumbnail image displayed in the sub window 301. On the other hand, when acquiring the information informing that the object cannot be detected, the application displays a pop-up window or the like on the display of the client PC 101 to inform the information to the user (Act 309).

According to the first embodiment, the object disposed on the page image is extracted from the print job data in order to generate the page image, and is stored in the object management server 103. Therefore, when the user wants to collect a specific object, it is possible to omit cumbersome operations, for example, an operation in which the object is searched in the file to be extracted.

In addition, according to the first embodiment, the user can search the stored object and use the detected object to create the document. In particular, according to the first embodiment, the user can search and use the stored object by using the text information input by the user or by using the reference image including the object in part or in whole. That is, since the plural means can be used for searching the object, the user can perform the object search easily.

### Second Embodiment

In a second embodiment of the invention, the print server 102 extracts the object from the print job data acquired by the client PC 101. Further, the print server 102 generates the meta data relating to the extracted object on the basis of the information extracted from the print job data. Then, the print server 102 associates the extracted object with the generated meta data to be registered on the object management server 103.

Therefore, in the second embodiment, the print server 102 is provided with the function of extracting the object from the print job data and the function of generating the meta data with respect to the object which are included in the printer driver 1 built on the client PC 101 in the first embodiment. That is, in the second embodiment, the print server 102 corresponds to the object acquisition device.

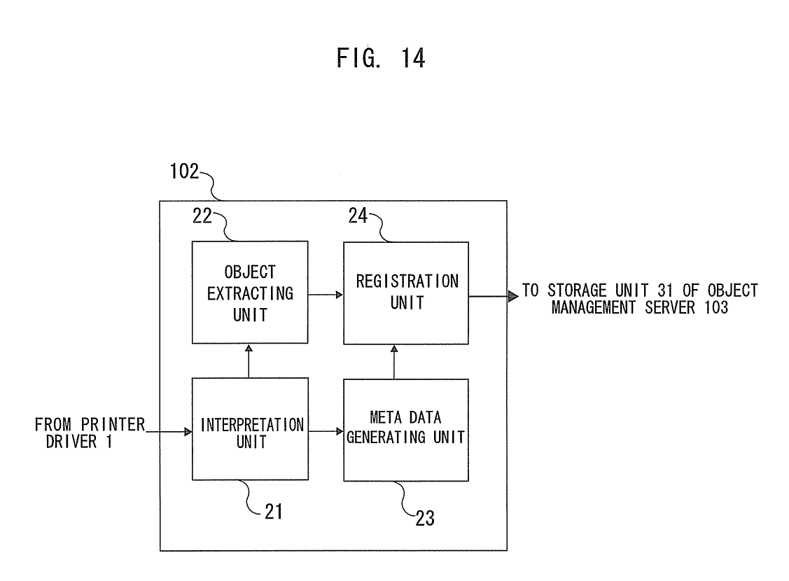

As shown in FIG. 14, in the second embodiment, the print server 102 includes an interpretation unit 21, an object extracting unit 22, a meta data generating unit 23, and a registration unit 24. The interpretation unit 21 performs the layout interpretation on the print job data for generating the acquired page image. In addition, the object extracting unit 22 extracts the object disposed on the page image on the basis of the layout interpretation by the interpretation unit 21. On the other hand, the meta data generating unit 23 generates the meta data which relates to the object extracted by the object extracting unit 22 as shown in FIG. 4 on the basis of the information extracted from the print job data. Then, the registration unit 24 associates the object extracted by the object extracting unit 22 with the meta data generated by the meta data generating unit 23, and then sends out all of which to the storage unit 31 of the object management server 103 to register the object and the meta data.

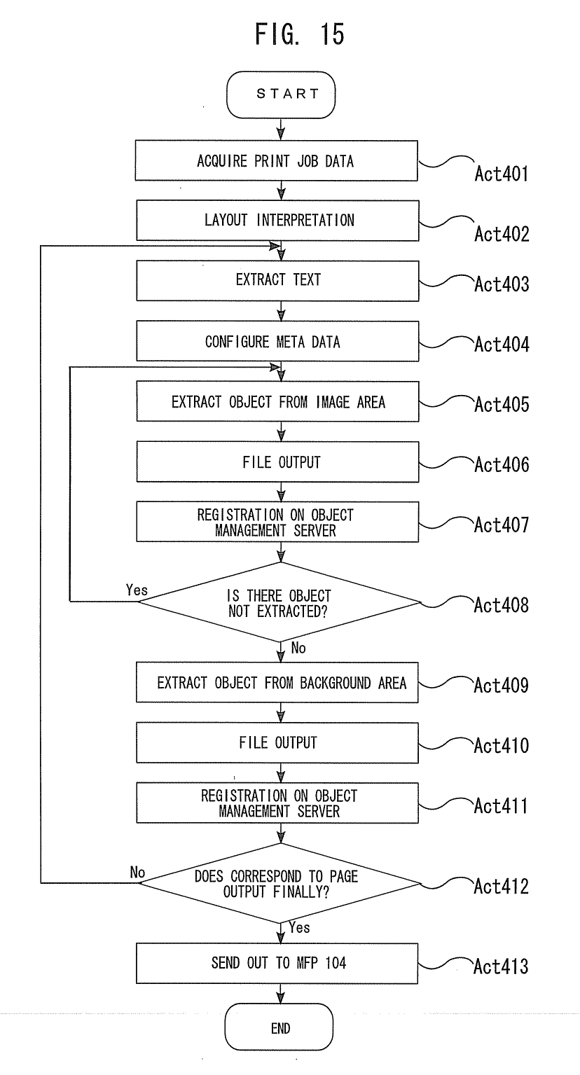

Hereinafter, the extraction of the object from the print job data and the generation of the meta data according to the second embodiment will be described in detail using FIG. 15.

First, in Act 401, the interpretation unit 21 acquires the print job data from the printer driver of the client PC 101. In the second embodiment, the print job data is described with the PDL. As an example of the PDL, the Post Script may be used.

Next, in Act 402, the interpretation unit 21 performs the layout interpretation on the print job data described with the PDL, and identifies the text area, the image area, the background area, and the like. Then, the interpretation unit 21 sends out the layout interpretation result to the object extracting unit 22 and the meta data generating unit 23.

In Act 403, the meta data generating unit 23 extracts the character code from the character drawing command of the text area identified by the layout interpretation result, and transforms the code into the text data on the basis of the acquired layout interpretation result from the interpretation unit 21.

Next, in Act 404, the meta data generating unit 23 performs, for example, the morphological analysis on the transformed text data to extract the nouns which are set as the keywords. Then, the meta data generating unit 23 generates the meta data by combining the set key words with the information relating to the print job data such as the time and data of printing acquired from the print job data described with the PDL, the file name, the logged-in user's name of the client PC. The meta data generating unit 23 sends out the generated meta data to the registration unit 24.

On the other hand, in Act 405, the object extracting unit 22 extracts the drawing command (object) from the image area identified by the layout interpretation result acquired from the interpretation unit 21. Next, in Act 406, the object extracting unit 22 outputs the acquired object as a file. The object extracting unit 22 sends out the output file of the object to the registration unit 24.

Then, in Act 407, the registration unit 24 associates the object file acquired from the object extracting unit 22 with the meta data acquired from the meta data generating unit 23, and registers all of which on the storage unit 31 of the object management server 103.

In Act 408, the object extracting unit 22 determines whether or not there is the object, which is not extracted in the image area, on the basis of the layout interpretation result. When there is the object not extracted (Yes in Act 408), the object extracting unit 22 and the registration unit 24 repeat the processes from Act 405 to Act 408.

When there is no object not extracted in the image area (No in Act 408), the object extracting unit 22 performs the object extraction also on the set of drawing commands included in the background area (Act 409). Next, the object extracting unit 22 outputs the extracted object as a file, and sends out the object file to the registration unit 24 (Act 410). Then, the registration unit 24 associates the object file with the meta data acquired from the meta data generating unit 13, and registers all of which on the storage unit 31 of the object management server 103 (Act 411).

In Act 412, the object extracting unit 22 determines whether or not the data subjected to the extraction of the object is the data corresponding to the page output finally among the print job data. When the data subjected to the extraction of the object does not the data corresponding to the page output finally among the print job data (No in Act 412), the printer driver 1 repeats the processes from Act 403 to Act 412.

When the data subjected to the extraction of the object is the data corresponding to the page output finally among the print job data (Yes in Act 412), the print server 103 sends out the spooled print job data to the MFP 104 and makes the print process to be performed (Act 413).

### Third Embodiment

In a third embodiment, the object management server 103 searches the stored object by using the reference image, and replaces the object included in the reference image with the detected object.

More specifically, in the third embodiment, the creation interpreting unit 11 of the printer driver I built on the client PC 101 acquires the drawing command of the document from the application similarly to the first embodiment. At this time, in the third embodiment, the drawing command may comply with a replacement command of the object included in the document. When the drawing command complies with the replacement command of the object, the creation interpreting unit 11 does not perform the layout interpretation on the created print job data, but sends out the data to the search unit 32 of the object management server 103. The search unit 32 acquiring the print job data performs the layout interpretation on the print job data, and extracts the object on the basis of the result of the layout interpretation. Next, the search unit 32 searches the object which is matched with or similar to the extracted object among the objects stored in the storage unit 31. Further, the search unit 32 reconfigures the print job data by using the detected object in order to replace the extracted object with the detected object. Then, the search unit 32 sends out the reconfigured print job data to the MFP 104.

When the user creates the document using the application, the document may include an unclear object, for example. In the past, the user did not satisfy the output of the printed document in many cases.

In this regard, in the third embodiment, the search unit 32 acquires the print job data (reference image) in order to search the object which includes the object in part or in whole and is stored in the storage unit 31. Next, the search unit 32 searches the object which is matched with or similar to the object included in the print job data among the objects stored in the storage unit 31. In addition, the search unit 32 replaces the object included in the print job data with the searched object (the detected object).

That is, in the third embodiment, when the drawing command of the document is sent out along with the replacement command of the document, the search unit 32 can replace the object included in the print job data with the object which is stored in the object management server 103 and is matched or similar. Therefore, according to the third embodiment, the user can acquire the printed document to be satisfied rather.

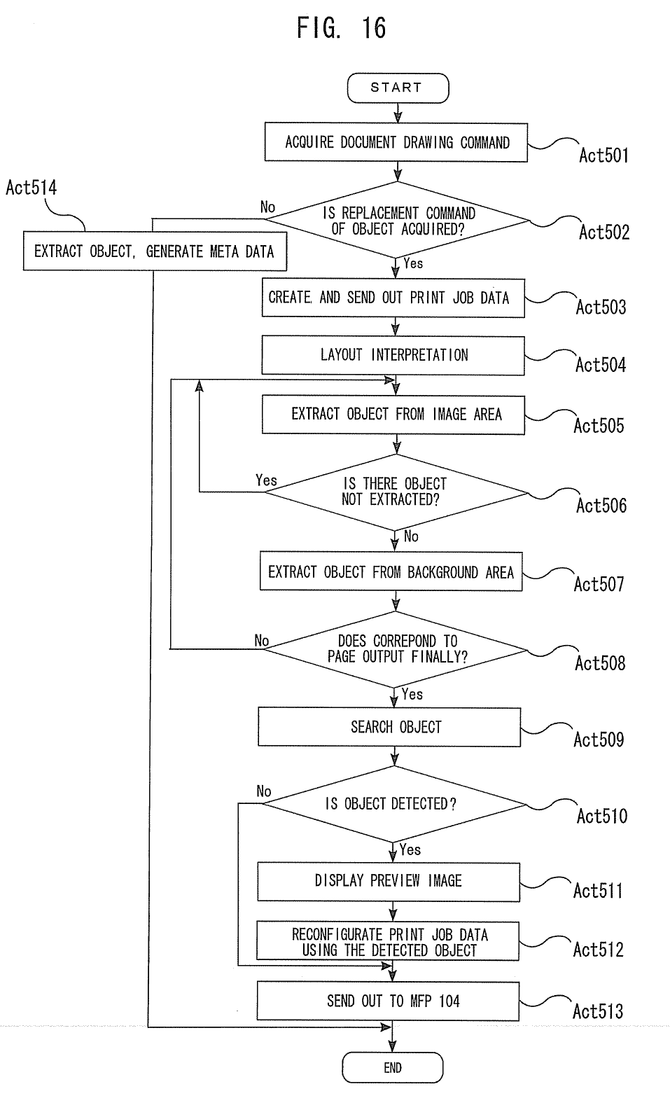

Hereinafter, a process for replacing the object included in the print job data with the object stored in the object management server 103 will be described in detail using FIG. 16.

First, in Act 501, the creation interpreting unit 11 of the printer driver 1 acquires the drawing command of the document. Next, in Act 502, the creation interpreting unit 11 determines whether or not the replacement command of the object is acquired along with the drawing command of the document.

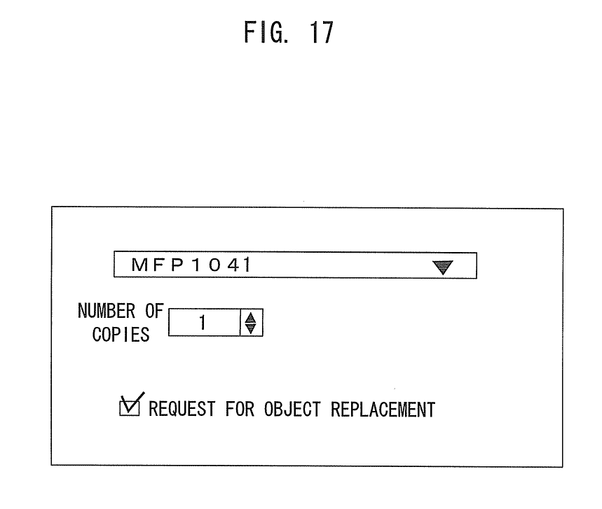

In addition, the replacement command of the object may be configured, for example, to be input by the user using the print instruction window for sending out the drawing command of the document which is displayed on the display of the client PC 101 as shown in FIG. 17. More specifically, for example, by inputting a check mark in a check box which is provided in the print instruction window to set whether or not the object replacement command is sent out, the user can send out the object replacement command to the application. In addition, it may be configured such that the information identifying the object, for example, the page number, in the document is designated. In this case, the replacement is implemented only on the designated object.

When the replacement command of the object is not acquired (No on Act 502), the creation interpreting unit 11 creates the print job data, and performs the extraction of the object and the generation of the meta data on the basis of the created print job data, and thereafter sends out the print job data to the MFP 104 (Act 514). Since the processes from the layout interpretation being performed to the print job data being sent out to the MFP 104 is the same as that of the first embodiment, the explanation thereof will be omitted.

On the other hand, when the replacement command of the object is acquired (Yes in Act 502), the creation interpreting unit 11 creates the print job data described with the PDL or the like, and sends out the print job data to the search unit 32 of the object management server 103 without performing the layout interpretation (Act 503). At this time, it may be configured such that the print job data is sent out to the search unit 32 via the print server 102.

In Act 504, when the print job data is acquired, the search unit 32 performs the layout interpretation on the print job data.

Next, in Act 505, the search unit 32 extracts the drawing command (object) from the image area identified by the layout interpretation result. The extracted object is spooled to the object spool area (not shown) of the data storage unit 31.

Then, in Act 506, the search unit 32 determines whether or not there is the object not extracted in the image area on the basis of the layout interpretation result. When there is the image area not subjected to the extraction of the object (Yes in Act 506), the search unit 32 repeats the processes from Act 505 to Act 506.

When there is no object not extracted (No in Act 506), the object extracting unit 22 performs the extraction of the object also on the set of the drawing commands included in the background area (Act 507). In this case, similarly to Act 505, the extracted object is spooled to the object spool area of the data storage unit 31.

In Act 508, the search unit 32 determines whether or not the data subjected to the extraction of the object is the data corresponding to the page output finally among the print job data. When the data subjected to the extraction of the object is not the data corresponding to the page output finally among the print job data (No in Act 508), the search unit 32 repeats the processes from Act 505 to Act 508.

When the data subjected to the extraction of the object is the data corresponding to the page output finally among the print job data (Yes in Act 508), the search unit 32 searches the object which is matched with or similar to the extracted object among the objects stored in the storage unit 31 (Act 509).

Here, in the third embodiment, similarly to the first embodiment, the object stored in the storage unit 31 is the vector image. Therefore, for example, the set of feature points of outlines is extracted from the image data (bit map) of the object in the reference image through image processing, and the extracted feature points are subjected to be matched with the feature points of the managed vector image. Accordingly, the object being matched with or similar to the extracted object may be searched.

In Act 510, the search unit 32 determines whether or not the object which is matched with or similar to the extracted object is detected.

When the object being matched or similar is detected (Yes in Act 510), a preview image of the detected object is displayed (Act 511). Here, when the preview image thereof is displayed, it may be configured such that the user checks whether or not the reconfiguration of the print job data is performed by using the detected object, and then the process proceeds to the next Act.

In Act 512, the search unit 32 reconfigures the print job data by using the detected object in order to replace a part or the entire part of the extracted object with the detected object.

Then, in Act 513, the search unit 32 sends out the replaced print job data to the MFP 104 to be output as the printed material.

On the other hand, when the object being matched or similar is not detected (No in Act 510), the search unit 32 proceeds from Act 510 to Act 513, and sends out the print job data itself to the MFP 104 without performing the reconfiguring processing.

In the third embodiment, the case where the printer driver 1 of the client PC 101 includes the object extracting function and the meta data generating function is exemplarily described. However, it is matter of course that the other configuration may be employed. Specifically, as in the second embodiment, even when the print server 102 includes the object extracting function and the meta data generating function, it is also possible to perform the replacement process of the object in the print job data on the object management server 103.

In addition, even when a copy function is performed in the MFP 104, it is possible to perform the replacement process of the object. That is, the MFP 104 sends out the image data acquired by using the scanner to the search unit 32 of the object management server 103. The search unit 32 replaces the object included in the acquired image data with the stored object to reconfigure the image data, and then sends out the reconfigured image data to the MFP 104. The MFP 104 outputs the image data, which is acquired and reconfigured, as a printed material.

### Other Embodiments

Hereinbefore, the embodiments of the invention were exemplified, but the invention is not limited thereto, and various changes can be made.

For example, the meta data which is associated with the object and registered may include other information on the object. As an example of such information, the information relating to a layout of the objects on the page image (a displacement location on the page image or an alignment direction of the objects), the number of the objects on the page image, a character associated with the object, the appearance frequency in the print job data, a size of the object, and a resolution of the object is exemplified. For example, the information may be added to the meta data such that the registration unit 14 associates the object with the meta data, and then generates the information on the basis of the layout interpretation, or the print job data is interpreted on the basis of the object.

In addition, when acquiring the reference image along with the object search request from the client PC 101, the object management server 103 maybe made to select the reference information associated with the object included in the reference image. In this case, the object management server 103 can search the object stored in the storage unit 31 on the basis of the selected reference information. Specifically, the search unit 32 may be made to search the object of which information matched or associated with the selected reference information is included in the associated meta data. In addition, the information selected by the search unit 32 as the reference information may be stored in the storage unit 31, or may be acquired via the network.

Further, the operations in the processes of the client PC 101, the print server 102, the object management server 103, and the MFP 104 described above are implemented by performing programs stored in the storage areas 101b, 102b, 103b, and 104b on the CPU 101a, 102a, 103a, and 104a, respectively.

Further, the programs for performing the above-mentioned operations may be provided as an object management program within the computer including the client PC 101, the print server 102, the object management server 103, and the MFP 104. In the first to third embodiments, it is shown the case by way of example, where the programs for realizing the functions which implement the invention are previously recorded in a storage area provided in the apparatus such as the client PC 101 and the print server 102. However, the invention is not limited thereto, and the similar program may be downloaded on the apparatus through the network. In addition, it may be configured such that an apparatus having a computer-readable recording medium stored with the similar program is installed on the apparatus. The recording medium is not particularly limited in shape as long as it can store the program and is a computer-readable recording medium. Specifically, as an example of the recording medium, there are an internal storage device such as a ROM or a RAM which is built in a computer, a transportable recording medium such as a CD-ROM or a flexible disk, a DVD disk, a magneto-optical disk, and an IC card, a data base with a computer program therein, or other computers and the data base thereof, or a transmission medium on a communication line. In addition, the functions obtained by the installation in advance or by downloading the program may be interworked with an operating system (OS) inside the apparatus to implement the functions.

It is assumed that the programs according to this embodiment include programs to be dynamically generated by execution modules.

The explanation of the invention is made about specific aspects in detail, but it will be apparent to those skilled in the art from this closure that various changes and modifications can be made herein without departing from the spirit and the scope of the invention.

According to the invention, it is possible to perform the acquisition and the management of the object used in the document.

What is claimed is:

1. An object acquisition device comprising:
an object extracting unit configured to extract an object disposed on a page image on the basis of print job data for generating the page image;
a meta data generating unit configured to generate meta data including information relating to the object extracted by the object extracting unit on the basis of information extracted from the print job data; and
a registration unit configured to register the object extracted by the object extracting unit and the meta data generated by the meta data generating unit by associating each other.

2. The device according to claim 1, wherein the meta data includes information relating to at least one of a layout of objects on the page image, the number of objects on the page image, a character associated with the object, an appearance frequency in the print job data, a size of the object, a resolution of the object, a created time and date of a file which is a basis of the print job data, a file name of the file which is the basis of the print job data, a created time and date of the print job data, a user's name who creates the print job data, a page number from which the object in the print job data is extracted, and a title of the page from which the object in the print job data is extracted.

3. The device according to claim 1, wherein the object includes at least one of a sign, a figure, a shape, and an image.

4. An object management system comprising:
an object extracting unit configured to extract an object disposed on a page image on the basis of print job data for generating the page image;
a meta data generating unit configured to generate meta data relating to the object extracted by the object extracting unit on the basis of information extracted from the print job data;
a storage unit configured to store the object and the meta data;
a registration unit configured to register the object extracted by the object extracting unit and the meta data generated by the meta data generating unit on the storage unit by associating each other; and
a search unit configured to search the object registered on the storage unit.

5. The system according to claim 4, wherein the search unit acquires reference information for searching the object stored in the storage unit, and searches an object of which information relating to the object in the meta data is matched or associated with a part or the entire part of the reference information among the objects stored in the storage unit.

6. The system according to claim 4, wherein the search unit acquires a reference image which is used for searching the object stored in the storage unit and includes an object in part or in whole, and searches the object which is matched with or similar to the object in part or in whole included in the reference image among the objects stored in the storage unit.

7. The system according to claim 4, further comprising a reference information generating unit configured to acquire a reference image which is used for searching the object stored in the storage unit and includes an object in part or in whole, and to generate information associated with the object included in the reference image, and
wherein the search unit searches an object of which information in the meta data is matched or associated with a part or the entire part of the reference information among the objects stored in the storage unit.

8. The system according to claim 4, wherein the search unit acquires a reference image which is used for searching the object stored in the storage unit and includes an object in part or in whole, and searches the object which is matched with or similar to the object included in the reference image among the object stored in the storage unit, and replaces the object included in the reference image with the searched object.

9. The system according to claim 4, wherein the meta data includes information relating to at least one of a layout of objects on the page image, the number of objects on the page image, a character associated with the object, an appearance frequency in the print job data, a size of the object, a resolution of the object, a created time and date of a file which is a basis of the print job data, a file name of the file which is the basis of the print job data, a created time and date of the print job data, a user's name who creates the print job data, a page number from which the object in the print job data is extracted, and a title of the page from which the object in the print job data is extracted.

10. The system according to claim 4, wherein the object includes at least one of a sign, a figure, a shape, and an image.

11. An object management method comprising:
extracting an object disposed on a page image on the basis of print job data for generating the page image;
generating meta data relating to the extracted object on the basis of information extracted from the print job data;
registering and storing the extracted object and the generated meta data by associating each other; and
searching the stored object.

12. The method according to claim 11, further comprising:
acquiring reference information for searching the stored object; and
searching an object of which information relating to the object in the meta data is matched or associated with a part or the entire part of the reference information among the stored objects.

13. The method according to claim 11, further comprising:
acquiring a reference image which is used for searching the stored object and includes an object in part or in whole; and
searching the object matched with or similar to the object in part or in whole included in the reference image among the stored objects.

14. The method according to claim 11, further comprising:
acquiring a reference image which is used for searching the stored object and includes an object in part or in whole;
generating information associated with the object included in the reference image; and
searching an object of which information in the meta data is matched or associated with a part or the entire part of the reference information among the stored objects.

15. The method according to claim 11, further comprising:
acquiring a reference image which is used for searching the stored object and includes an object in part or in whole;
searching the object which is matched with or similar to the object included in the reference image among the stored objects; and
replacing the object included in the reference image with the searched object.

16. The method according to claim 11, wherein the meta data includes information relating to at least one of a layout of objects on the page image, the number of objects on the page image, a character associated with the object, an appearance frequency in the print job data, a size of the object, a resolution of the object, a created time and date of a file which is a basis of the print job data, a file name of the file which is the basis of the print job data, a created time and date of the print job data, a user's name who creates the print job data, a page number from which the object in the print job data is extracted, and a title of the page from which the object in the print job data is extracted.

17. The method according to claim 11, wherein the object includes at least one of a sign, a figure, a shape, and an image.
